(19) United States
(12) Patent Application Publication
(10) Pub. No.: US 2004/0163012 A1
(43) Pub. Date: Aug. 19, 2004

(54) Multiprocessor system capable of efficiently debugging processors

(75) Inventor: Kiyoshi Hayase, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 10/654,893

(22) Filed: Sep. 5, 2003

(30) Foreign Application Priority Data
Nov. 14, 2002 (JP) 2002-330310

(51) Int. Cl. H02H 3/05

(52) U.S. Cl. 714/25

(57) ABSTRACT

A multiprocessor system is obtained which is capable of efficiently debugging a plurality of processors, while allowing cost reduction. A chip (1) has CPUs (7₀, 7₁), debug executing units (8₀, 8₁), TAP controllers (9₀, 9₁), a selecting circuit (10), and a single set of terminals including terminals (2) to (6). When only the CPU (7₀) is to be debugged, a TAP controller (100) sets a register (101) so that a signal (S11) is “H” and a signal (S12) is “L.” When only the CPU (7₁) is to be debugged, the TAP controller (100) sets the register (101) so that the signal (S11) is “L” and the signal (S12) is “H.” When both CPUs (7₀) and (7₁) are to be debugged, the TAP controller (100) sets the register (101) so that the signals (S11) and (S12) are both “H.”

### BACKGROUND OF THE INVENTION

1. Field of the Invention

The present invention relates to multiprocessor systems, and particularly to a multiprocessor system capable of efficiently debugging the processors.

2. Description of the Background Art

A first conventional multiprocessor system has the same number of sets of debugging terminals as the processors provided therein. Debugging devices are respectively connected to the corresponding sets of terminals so that the processors can be independently debugged by the corresponding debugging devices.

A second conventional multiprocessor system has a single set of debugging terminals, and TAP controllers respectively connected to the processors are serially connected each other so that all processors can be debugged with a single debugging device.

The Patent Documents 1 and 2 below describe techniques about the debugging of processors.

Patent Document 1: Japanese Patent Application Laid-Open No. 2002-73363.

Patent Document 2: Japanese Patent Application Laid-Open No. 2002-24201.

According to the first conventional multiprocessor system, providing additional processors requires adding corresponding sets of debugging terminals and corresponding debugging devices, leading to an increase in cost.

According to the second conventional multiprocessor system, the debugging is always applied serially to all processors through all TAP controllers, requiring a long debugging time.

### SUMMARY OF THE INVENTION

An object of the present invention is to obtain a multiprocessor system that is capable of efficiently debugging a plurality of processors, while allowing cost reduction.

According to a first aspect of the present invention, a multiprocessor system includes a plurality of processors, at least one debug executing unit, at least one controller, a set of terminals, and a selecting circuit. The debug executing unit executes the debugging of the plurality of processors. The controller controls the debug executing unit. The set of terminals are to be connected to an external debugging device. The selecting circuit selects part or all of the plurality of processors to be debugged.

Desired one or ones of the processors can be debugged using only a single debugging device, which allows a cost reduction.

According to a second aspect of the invention, a multiprocessor system includes first and second processors, first and second debug executing units, first and second controllers, first and second sets of terminals, and a selecting circuit. The first debug executing unit is connected to the first processor and the second debug executing unit is connected to the second processor. The first controller is connected to the first debug executing unit and the second controller is connected to the second debug executing unit. The first set of terminals are selectively connected to the first controller and the second set of terminals are selectively connected to the second controller. The selecting circuit is connected between the first set of terminals and the first and second controllers. In a first mode in which debugging devices are connected respectively to the first and second sets of terminals, the selecting circuit connects the first controller and the first set of terminals, and connects the second controller and the second set of terminals. In a second mode in which the debugging device is connected only to the first set of terminals, the selecting circuit inputs, to one or both of the first and second controllers, a debugging signal provided from the debugging device through the first set of terminals.

The first mode and the second mode can be switched over in accordance with the number of debugging device(s) that can be prepared, so that the first and second processors can be debugged suitably.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a multiprocessor system according to a first preferred embodiment of the invention;

FIG. 2 is a block diagram showing the configuration of a multiprocessor system according to a second preferred embodiment of the invention;

FIG. 3 is a block diagram showing the configuration of a multiprocessor system according to a third preferred embodiment of the invention;

FIG. 4 is a block diagram showing the configuration of a multiprocessor system according to a fourth preferred embodiment of the invention;

FIG. 5 is a block diagram showing the configuration of a multiprocessor system according to a fifth preferred embodiment of the invention;

FIG. 6 is a block diagram showing the configuration of a multiprocessor system according to a sixth preferred embodiment of the invention; and

FIG. 7 is a block diagram showing the configuration of a multiprocessor system according to a seventh preferred embodiment of the invention.

### DESCRIPTION OF THE PREFERRED EMBODIMENTS

Preferred Embodiments of the present invention are now specifically described with, for the sake of simplicity, an example multiprocessor system having two CPUs. Note that the number of CPUs is not limited to two and the present invention can be applied also to multiprocessors having three or more CPUs.

### First Preferred Embodiment

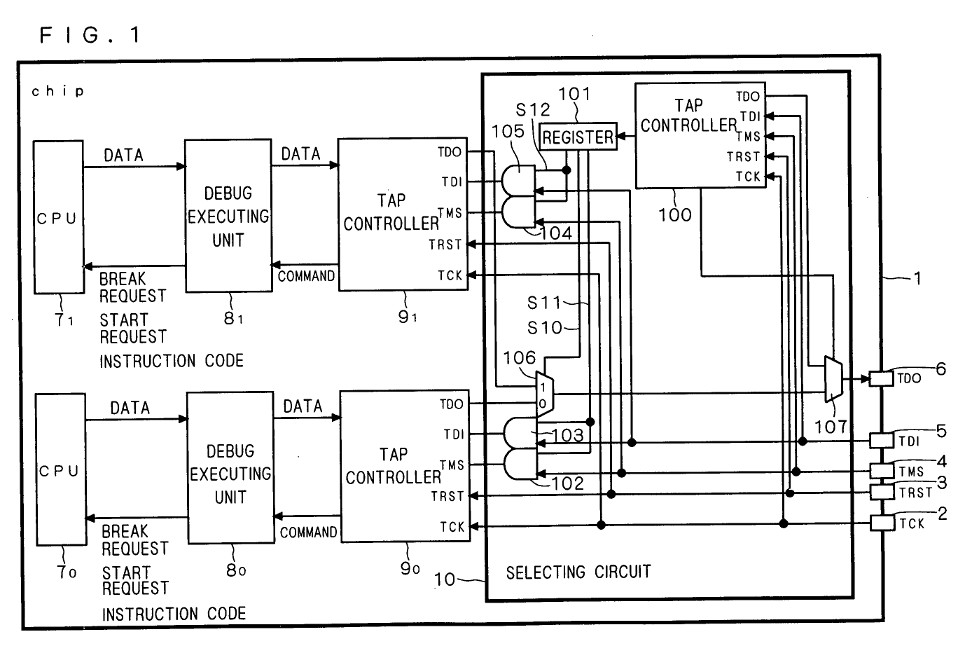

FIG. 1 is a block diagram showing the configuration of a multiprocessor system according to a first preferred embodiment of the invention. A chip 1 has a plurality of CPUs 7₀ and 7₁, debug executing units 8₀ and 8₁ for executing the debugging of the CPUs 7₀ and 7₁, TAP controllers 9₀ and 9₁ for controlling the debug executing units 8₀ and 8₁, a selecting circuit 10 for selecting, from the CPUs 7₀ and 7₁, at least one CPU to be debugged, and a single set of terminals, including terminals 2 to 6. The CPUs 7₀ and 7₁ are connected respectively to the debug executing units 8₀ and 8₁, and the debug executing units 8₀ and 8₁ are connected respectively to the TAP controllers 9₀ and 9₁. The selecting circuit 10 is connected between the TAP controllers 9₀, 9₁ and the terminals 2 to 6. The terminals 2 to 6 are connected to a debugging device (not shown), such as an ICE that conforms to JTAG standards.

The selecting circuit 10 includes a TAP controller 100, a register 101, AND circuits 102 to 105, and selectors 106 and 107. The AND circuit 102 has its first input terminal connected to the terminal 4, its second input terminal connected to the register 101, and its output terminal connected to the TMS terminal of the TAP controller 9₀. The AND circuit 103 has its first input terminal connected to the terminal 5, its second input terminal connected to the register 101, and its output terminal connected to the TDI terminal of the TAP controller 9₀. The AND circuit 104 has its first input terminal connected to the terminal 4, its second input terminal connected to the register 101, and its output terminal connected to the TMS terminal of the TAP controller 9₁. The AND circuit 105 has its first input terminal connected to the terminal 5, its second input terminal connected to the register 101, and its output terminal connected to the TDI terminal of the TAP controller 9₁. The selector 106 has its first input terminal connected to the TDO terminal of the TAP controller 9₀, its second input terminal connected to the TDO terminal of the TAP controller 9₁, and its output terminal connected to the terminal 6 through the selector 107.

Next, operation of the multiprocessor system of the first preferred embodiment is described. First, in order to select a CPU or CPUs to be debugged, the TAP controller 100 is accessed from the debugging device or CPU(s) 7₀, 7₁. When debugging only the CPU 7₀, the TAP controller 100 sets the register 101 so that a signal S11 is “H (High),” a signal S12 is “L (Low),” and a signal S10 is “L.” When debugging only the CPU 7₁, the TAP controller 100 sets the register 101 so that the signal S11 is “L,” the signal S12 is “H,” and the signal S10 is “H.” When debugging both CPUs 7₀, 7₁, the TAP controller 100 sets the register 101 so that the signals S11 and S12 are both “H.” In this case, the register 101 is set so that the signal S10 sequentially attains “L” and “H.”

The signal S11 is inputted to the second input terminals of the AND circuits 102 and 103. The signal S12 is inputted to the second input terminals of the AND circuits 104 and 105. The signal S10 is inputted to the select terminal of the selector 106.

A TMS signal from the debugging device is given through the terminal 4 to the first input terminals of the AND circuits 102 and 104, and a TDI signal from the debugging device is given through the terminal 5 to the first input terminals of the AND circuits 103 and 105. Also, a TCK signal from the debugging device is given through the terminal 2 to the TCK terminals of the TAP controllers 9₀ and 9₁, and a TRST signal from the debugging device is given through the terminal 3 to the TRST terminals of the TAP controllers 9₀ and 9₁.

As stated earlier, when only the CPU 7₀ is to be debugged, the signal S11 is “H” and the signal S12 is “L.” Therefore the TMS signal and the TDI signal are inputted respectively to the TMS terminal and TDI terminal of the TAP controller 9₀ from the output terminals of the AND circuits 102 and 103, respectively. The TMS signal and the TDI signal are not provided to the TMS terminal and the TDI terminal of the TAP controller 9₁.

The TAP controller 9₀ then generates a given command to the debug executing unit 8₀. The debug executing unit 8₀ provides a break request, start request, and instruction code to the CPU 7₀, so as to debug the CPU 7₀. Data about the results of debugging is sent from the CPU 7₀ to the TAP controller 9₀ through the debug executing unit 8₀. As stated earlier, the signal S10 is “L” when only the CPU 7₀ is debugged. The selector 107 is normally set to the selector 106. The data is therefore externally outputted from the TDO terminal of the TAP controller 9₀, through the selectors 106, 107 and the terminal 6.

On the other hand, when only the CPU 7₁ is to be debugged, the signal S11 is “L” and the signal S12 is “H.” Therefore the TMS signal and the TDI signal are inputted respectively to the TMS terminal and TDI terminal of the TAP controller 9₁ from the output terminals of the AND circuits 104 and 105. The TMS signal and the TDI signal are not provided to the TMS terminal and the TDI terminal of the TAP controller 9₀.

The TAP controller 9₁ then generates a given command to the debug executing unit 8₁. The debug executing unit 8₁ provides a break request, start request, and instruction code to the CPU 7₁, so as to debug the CPU 7₁. Data about the results of debugging is sent from the CPU 7₁ to the TAP controller 9₁ through the debug executing unit 8₁. As stated earlier, the signal S10 is “H” when only the CPU 7₁ is debugged. The selector 107 is normally set to the selector 106. The data is therefore externally outputted from the TDO terminal of the TAP controller 9₁, through the selectors 106, 107 and the terminal 6.

When both the CPUs 7₀, 7₁ are to be debugged, the signals S11 and S12 are both “H” as stated earlier. Thus the TMS signal is inputted to the TMS terminals of the TAP controllers 9₀ and 9₁ respectively from the output terminals of the AND circuits 102 and 104. Also, the TDI signal is inputted to the TDI terminals of the TAP controllers 9₀ and 9₁ respectively from the output terminals of the AND circuits 103 and 105. As a result, the CPUs 7₀ and 7₁ are debugged in the manner shown above.

As stated earlier, the signal S10 sequentially goes “L” and “H” when debugging both CPUs 7₀, 7₁. Therefore the terminal 6 outputs data about the results of debugging of the CPU 7₀ and data about the results of debugging of the CPU 7₁ in this order.

In this way, the multiprocessor system of the first preferred embodiment includes just a single set of terminals including the terminals 2 to 6, and the selecting circuit 10 selects at least one CPU to be debugged, from among the plurality of CPUs 7₀ and 7₁. Therefore providing an increased number of CPUs in the chip 1 does not require adding corresponding terminals 2 to 6. The plurality of CPUs 7₀ and 7₁ can thus be debugged using only a single debugging device, allowing a cost reduction.

When the selecting circuit 10 selects all CPUs 7₀ and 7₁, then all CPUs 7₀ and 7₁ are debugged simultaneously. Thus, in a multiprocessor system having a plurality of CPUs 7₀ and 7₁, the CPUs 7₀ and 7₁ can be debugged efficiently.

Moreover, the selecting circuit 10 is simply configured using the register 101, which minimizes the size and complexity of the system.

### Second Preferred Embodiment

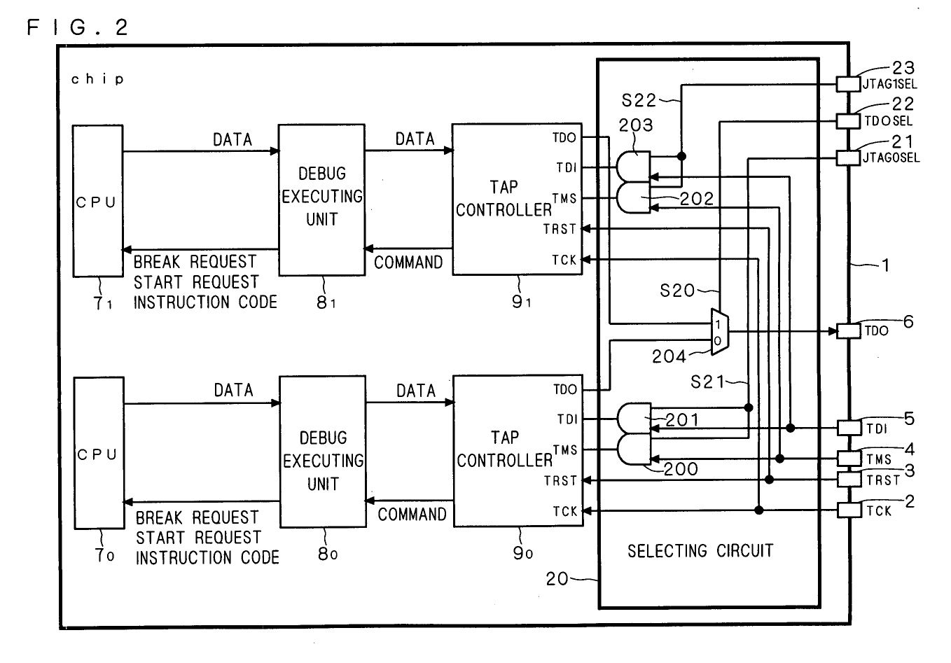

FIG. 2 is a block diagram showing the configuration of a multiprocessor system according to a second preferred embodiment of the invention. A chip 1 has CPUs 7₀ and 7₁, debug executing units 8₀ and 8₁, TAP controllers 9₀ and 9₁, a selecting circuit 20 for selecting, from the CPUs 7₀ and 7₁, at least one CPU to be debugged, terminals 2 to 6, and terminals 21 to 23.

The selecting circuit 20 includes AND circuits 200 to 203 and a selector 204. The AND circuit 200 has its first input terminal connected to the terminal 4, its second input terminal connected to the terminal 21, and its output terminal connected to the TMS terminal of the TAP controller 9₀. The AND circuit 201 has its first input terminal connected to the terminal 5, its second input terminal connected to the terminal 21, and its output terminal connected to the TDI terminal of the TAP controller 9₀. The AND circuit 202 has its first input terminal connected to the terminal 4, its second input terminal connected to the terminal 23, and its output terminal connected to the TMS terminal of the TAP controller 9₁. The AND circuit 203 has its first input terminal connected to the terminal 5, its second input terminal connected to the terminal 23, and its output terminal connected to the TDI terminal of the TAP controller 9₁. The selector 204 has its first input terminal connected to the TDO terminal of the TAP controller 9₀, its second input terminal connected to the TDO terminal of the TAP controller 9₁, and its output terminal connected to the terminal 6.

Next, operation of the multiprocessor system of the second preferred embodiment is described. First, in order to select a CPU or CPUs to be debugged, signals S21, S20, and S22 are inputted respectively to the terminals 21, 22, 23, from the outside of the chip 1. When only the CPU 7₀ is to be debugged, the signal S21 is “H,” the signal S22 is “L,” and the signal S20 is “L.” When only the CPU 7₁ is to be debugged, the signal S21 is “L,” the signal S22 is “H” and the signal S20 is “H.” When both CPUs 7₀, 7₁, are to be debugged, both of the signals S21 and S22 are “H.” In this case, the signal S20 sequentially attains “L” and “H.”

The signal S21 is inputted to the second input terminals of the AND circuits 200 and 201. The signal S22 is inputted to the second input terminals of the AND circuits 202 and 203. The signal S20 is inputted to the select terminal of the selector 204.

The TMS signal from the debugging device is inputted to the first input terminals of the AND circuits 200 and 202 through the terminal 4. The TDI signal from the debugging device is inputted to the first input terminals of the AND circuits 201 and 203 through the terminal 5.

When only the CPU 7₀ is debugged, the signal S21 is “H” and the signal S22 is “L” as stated above. Therefore the TMS signal and the TDI signal are inputted respectively to the TMS terminal and TDI terminal of the TAP controller 9₀ respectively from the output terminals of the AND circuits 200 and 201. The TMS signal and the TDI signal are not provided to the TMS and TDI terminals of the TAP controller 9₁. As a result, only the CPU 7₀ is debugged in the manner described in the first preferred embodiment. As stated earlier, the signal S20 is “L” when only the CPU 7₀ is debugged. Data about the results of debugging of the CPU 7₀ is therefore externally outputted through the TDO terminal of the TAP controller 9₀, the selector 204, and the terminal 6.

When only the CPU 7₁ is to be debugged, the signal S21 is “L” and the signal S22 is “H” as stated above. Therefore the TMS signal and the TDI signal are inputted respectively to the TMS terminal and the TDI terminal of the TAP controller 9₁ respectively from the output terminals of the AND circuits 202 and 203. The TMS and TDI signals are not inputted to the TMS and TDI terminals of the TAP controller 9₀. As a result, only the CPU 7₁ is debugged in the manner described in the first preferred embodiment. As stated earlier, the signal S20 is “H” when only the CPU 7₁ is debugged. Data about the results of debugging of the CPU 7₁ is therefore externally outputted through the TDO terminal of the TAP controller 9₁, the selector 204, and the terminal 6.

When both the CPUs 7₀, 7₁ are to be debugged, the signals S21 and S22 are both “H” as stated above. Therefore the TMS signal is inputted to the TMS terminals of the TAP controllers 9₀ and 9₁ respectively from the output terminals of the AND circuits 200 and 202. The TDI signal is inputted to the TDI terminals of the TAP controllers 9₀ and 9₁ respectively from the output terminals of the AND circuits 201 and 203. As a result, the CPUs 7₀ and 7₁ are debugged. As indicated above, the signal S20 sequentially goes “L,” “H” when debugging both CPUs 7₀, 7₁. Therefore the terminal 6 outputs data about the results of debugging of the CPU 7₀ and data about the results of debugging of the CPU 7₁ in this order.

In this way, the multiprocessor system of the second preferred embodiment includes just a single set of terminals, including the terminals 2 to 6, and the selecting circuit 20 selects at least one of the plurality of CPUs 7₀ and 7₁ to be debugged. Therefore providing an increased number of CPUs in the chip 1 does not require adding corresponding terminals 2 to 6. Thus the plurality of CPUs 7₀ and 7₁ can be debugged using only a single debugging device, which achieves a cost reduction.

When the selecting circuit 20 selects all CPUs 7₀ and 7₁, then all CPUs 7₀ and 7₁ are debugged simultaneously. Thus, in a multiprocessor system having a plurality of CPUs 7₀ and 7₁, the CPUs 7₀ and 7₁ can be debugged efficiently.

Moreover, the selecting circuit 20 is simply configured using the terminals 21 to 23, which minimizes the size and complexity of the system.

### Third Preferred Embodiment

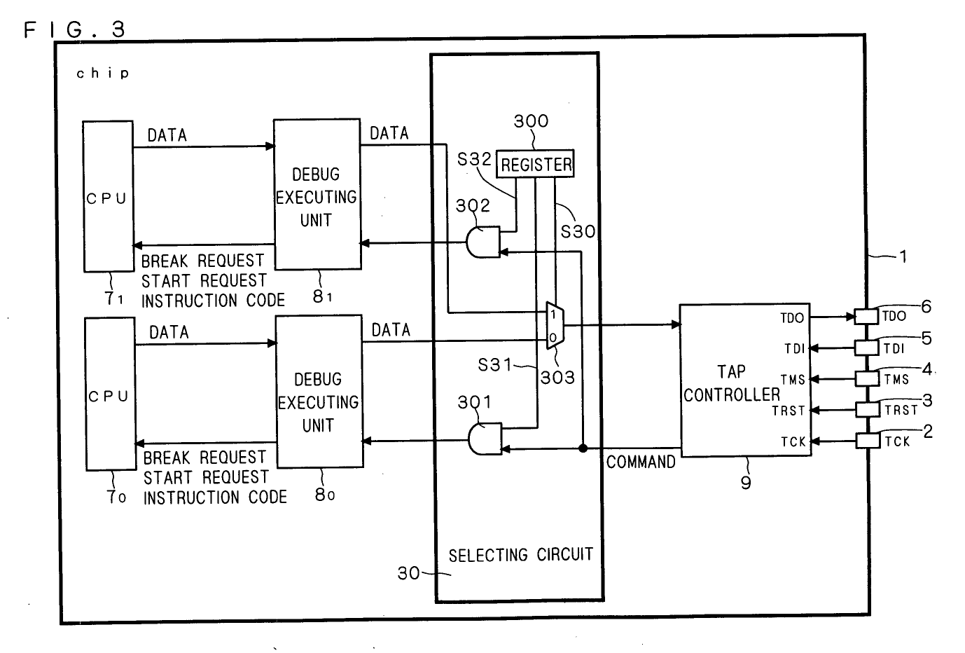

FIG. 3 is a block diagram showing the configuration of a multiprocessor system according to a third preferred embodiment of the invention. A chip 1 has a plurality of CPUs 7₀ and 7₁, debug executing units 8₀ and 8₁, a TAP controller 9 for controlling the debug executing units 8₀ and 8₁, a selecting circuit 30 for selecting, from the CPUs 7₀ and 7₁, at least one CPU to be debugged, and a single set of terminals including terminals 2 to 6. The CPUs 7₀ and 7₁ are connected respectively to the debug executing units 8₀ and 8₁ and the TAP controller 9 is connected to the terminals 2 to 6. The selecting circuit 30 is connected between the debug executing units 8₀, 8₁ and the TAP controller 9.

The selecting circuit 30 includes a register 300, AND circuits 301 and 302, and a selector 303. The AND circuit 301 has its first input terminal connected to the TAP controller 9, its second input terminal connected to the register 300, and its output terminal connected to the debug executing unit 8₀. The AND circuit 302 has its first input terminal connected to the TAP controller 9, its second input terminal connected to the register 300, and its output terminal connected to the debug executing unit 8₁. The selector 303 has its first input terminal connected to the debug executing unit 8₀, its second input terminal connected to the debug executing unit 8₁, and its output terminal connected to the TAP controller 9.

Next, operation of the multiprocessor system of the third preferred embodiment is described. First, in order to select a CPU or CPUs to be debugged, the register 300 is accessed by a debugging device or the CPU(s) 7₀, 7₁. When only the CPU 7₀ is to be debugged, the register 300 is set so that the signal S31 is “H,” the signal S32 is “L,” and the signal S30 is “L.” When only the CPU 7₁ is to be debugged, the register 300 is set so that the signal S31 is “L,” the signal S32 is “H,” and the signal S30 is “H.” When both CPUs 7₀, 7₁ are to be debugged, the register 300 is set so that the signals S31 and S32 are both “H.” In this case, the register 300 is set so that the signal S30 sequentially attains “L” and “H.”

The signal S31 is inputted to the second input terminal of the AND circuit 301. The signal S32 is inputted to the second input terminal of the AND circuit 302. The signal S30 is inputted to the select terminal of the selector 300.

Next, the TCK signal, TRST signal, TMS signal, and TDI signal from the debugging device are inputted respectively to the TCK terminal, TRST terminal, TMS terminal, and TDI terminal of the TAP controller 9 respectively through the terminals 2 to 5. The TAP controller 9 then generates and outputs a given command.

When only the CPU 7₀ is to be debugged, the signal S31 is “H” and the signal S32 is “L” as stated above. Therefore the command from the TAP controller 9 is outputted from the output terminal of the AND circuit 301 into the debug executing unit 8₀. The command is not inputted to the debug executing unit 8₁.

The debug executing unit 8₀ gives a break request, start request, and instruction code to the CPU 7₀, so as to debug the CPU 7₀. Data about the results of the debugging is inputted from the CPU 7₀ to the debug executing unit 8₀. As stated earlier, the signal S30 is “L” when only the CPU 7₀ is debugged. The data is therefore externally outputted through the debug executing unit 8₀, selector 303, TAP controller 9, and terminal 6.

When only the CPU 7₁ is to be debugged, the signal S31 is “L” and the signal S32 is “H” as stated above. Therefore the command from the TAP controller 9 is outputted from the output terminal of the AND circuit 302 into the debug executing unit 8₁. The command is not inputted to the debug executing unit 8₀.

The debug executing unit 8₁ gives a break request, start request, and instruction code to the CPU 7₁, so as to debug the CPU 7₁. Data about the results of the debugging is inputted from the CPU 7₁ to the debug executing unit 8₁. As stated earlier, the signal S30 is “H” when only the CPU 7₁ is debugged. The data is therefore externally outputted through the debug executing unit 8₁, selector 303, TAP controller 9, and terminal 6.

When both the CPUs 7₀, 7₁ are to be debugged, the signals S31 and S32 are both “H” as stated above. Therefore the command from the TAP controller 9 is outputted from the output terminals of the AND circuits 301 and 302 into the debug executing units 8₀ and 8₁, respectively. As a result, the CPUs 7₀ and 7₁ are debugged in the manner described earlier. As indicated before, the signal S30 sequentially goes “L” and “H” when debugging both CPUs 7₀, 7₁. Therefore the terminal 6 outputs data about the results of debugging of the CPU 7₀ and data about the results of debugging of the CPU 7₁ in this order.

In the system shown above, the selecting circuit 30 selects debugged CPU 7₀, 7₁, on the basis of the settings of the register 300. However, the selection may be made as shown in the second preferred embodiment on the basis of select signals inputted to given terminals 21 to 23 from outside.

In this way, in the multiprocessor system of the third preferred embodiment, the selecting circuit 30 is connected between the debug executing units 8₀, 8₁ and the TAP controller 9. Accordingly there is no need to separately provide TAP controllers 9₀ and 9₁ in correspondence with the CPUs 7₀ and 7₁, so that the system configuration can be simplified as compared with those shown in the first and second preferred embodiments.

### Fourth Preferred Embodiment

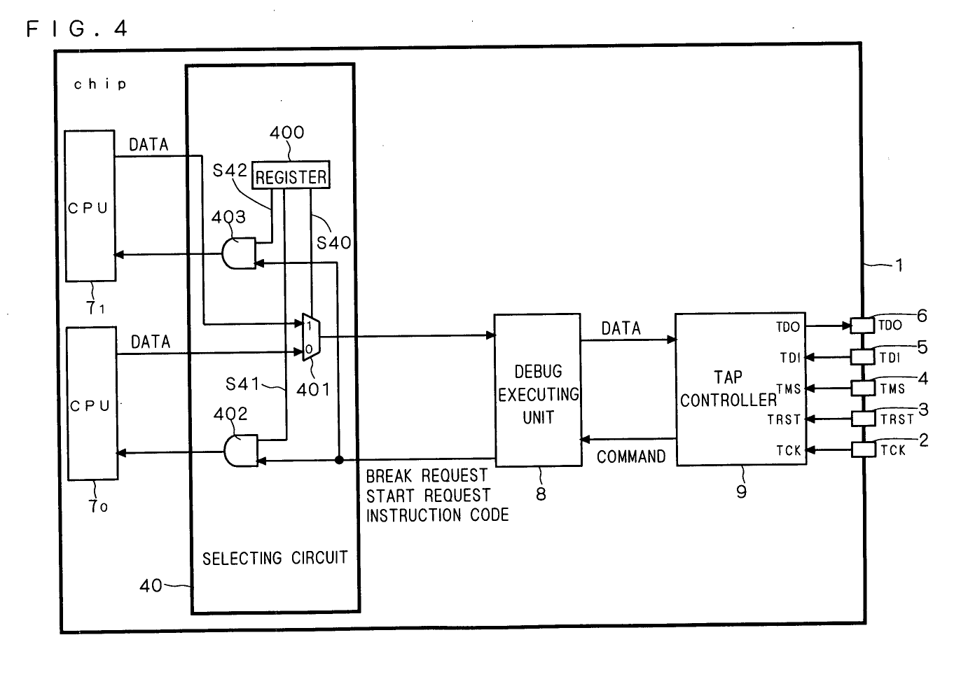

FIG. 4 is a block diagram showing the configuration of a multiprocessor system according to a fourth preferred embodiment of the invention. A chip 1 has a plurality of CPUs 7₀ and 7₁, a debug executing unit 8, a TAP controller 9 for controlling the debug executing unit 8, a selecting circuit 40 for selecting, from the CPUs 7₀ and 7₁, at least one CPU to be debugged, and a single set of terminals including terminals 2 to 6. The TAP controller 9 is connected to the terminals 2 to 6 and the debug executing unit 8 is connected to the TAP controller 9. The selecting circuit 40 is connected between the CPUs 7₀, 7₁ and the debug executing unit 8.

The selecting circuit 40 includes a register 400, AND circuits 402 and 403, and a selector 401. The AND circuit 402 has its first input terminal connected to the debug executing unit 8, its second input terminal connected to the register 400, and its output terminal connected to the CPU 7₀. The AND circuit 403 has its first input terminal connected to the debug executing unit 8, its second input terminal connected to the register 400, and its output terminal connected to the CPU 7₁. The selector 401 has its first input terminal connected to the CPU 7₀, its second input terminal connected to the CPU 7₁, and its output terminal connected to the debug executing unit 8.

Next, operation of the multiprocessor system of the fourth preferred embodiment is described. First, in order to select a CPU or CPUs to be debugged, the register 400 is accessed by a debugging device or the CPU(s) 7₀, 7₁. When only the CPU 7₀ is to be debugged, the register 400 is set so that the signal S41 is “H,” the signal S42 is “L,” and the signal S40 is “L.” When only the CPU 7₁ is to be debugged, the register 400 is set so that the signal S41 is “L,” the signal S42 is “H” and the signal S40 is “H.” When both CPUs 7₀, 7₁ are to be debugged, the register 400 is set so that both of the signals S41 and S42 are “H.” In this case, the register 400 is set so that the signal S40 sequentially attains “L” and “H.”

The signal S41 is inputted to the second input terminal of the AND circuit 402. The signal S42 is inputted to the second input terminal of the AND circuit 403. The signal S40 is inputted to the select terminal of the selector 400.

Next, the TCK signal, TRST signal, TMS signal, and TDI signal from the debugging device are inputted respectively to the TCK terminal, TRST terminal, TMS terminal, and TDI terminal of the TAP controller 9 respectively through the terminals 2 to 5. The TAP controller 9 then generates and outputs a given command. The command from the TAP controller 9 is inputted to the debug executing unit 8. The debug executing unit 8 generates and outputs a break request, start request, and instruction code.

When only the CPU 7₀ is debugged, the signal S41 is “H” and the signal S42 is “L” as stated above. Therefore the instruction code and the like from the debug executing unit 8 are outputted from the output terminal of the AND circuit 402 and inputted into the CPU 7₀, and thus the CPU 7₀ is debugged. The instruction code etc. are not inputted to the CPU 7₁. As stated earlier, the signal S40 is “L” when only the CPU 7₀ is debugged. Therefore data about the results of debugging of CPU 7₀ is externally outputted from the CPU 7₀ through the selector 401, debug executing unit 8, TAP controller 9, and terminal 6.

When only the CPU 7₁ is debugged, the signal S41 is “L” and the signal S42 is “H” as stated earlier. Therefore the instruction code and the like from the debug executing unit 8 are outputted from the output terminal of the AND circuit 403 and inputted into the CPU 7₁, and thus the CPU 7₁ is debugged. The instruction code etc. are not inputted to the CPU 7₀. As stated earlier, the signal S40 is “H” when only the CPU 7₁ is debugged. Therefore data about the results of the debugging of the CPU 7₁ is externally outputted from the CPU 7₁ through the selector 401, debug executing unit 8, TAP controller 9, and terminal 6.

When both the CPU 7₀ and 7₁ are debugged, the signals S41 and S42 are both “H.” Therefore the instruction code and the like from the debug executing unit 8 are outputted from the output terminals of the AND circuits 402 and 403 and inputted into the CPUs 7₀ and 7₁, and thus the CPUs 7₀ and 7₁ are debugged in the manner described above. As stated earlier, the signal S40 sequentially goes “L” and “H” when the CPUs 7₀ and 7₁ are both debugged. Therefore the terminal 6 outputs data about the results of debugging of the CPU 7₀ and data about the results of debugging of the CPU 7₁ in this order.

In the system described above, the selecting circuit 40 selects debugged CPU(s) 7₀, 7₁ on the basis of the settings of the register 400. However, the selection may be made as shown in the second preferred embodiment on the basis of select signals inputted to given terminals 21 to 23 from outside.

In this way, in the multiprocessor system of the fourth preferred embodiment, the selecting circuit 40 is connected between the CPUs 7₀, 7₁ and the debug executing unit 8. Accordingly there is no need to separately provide debug executing units 8₀ and 8₁ and TAP controllers 9₀ and 9₁ in correspondence with the CPUs 7₀ and 7₁, so that the system configuration can be simplified as compared with those shown in the first and second preferred embodiments.

### Fifth Preferred Embodiment

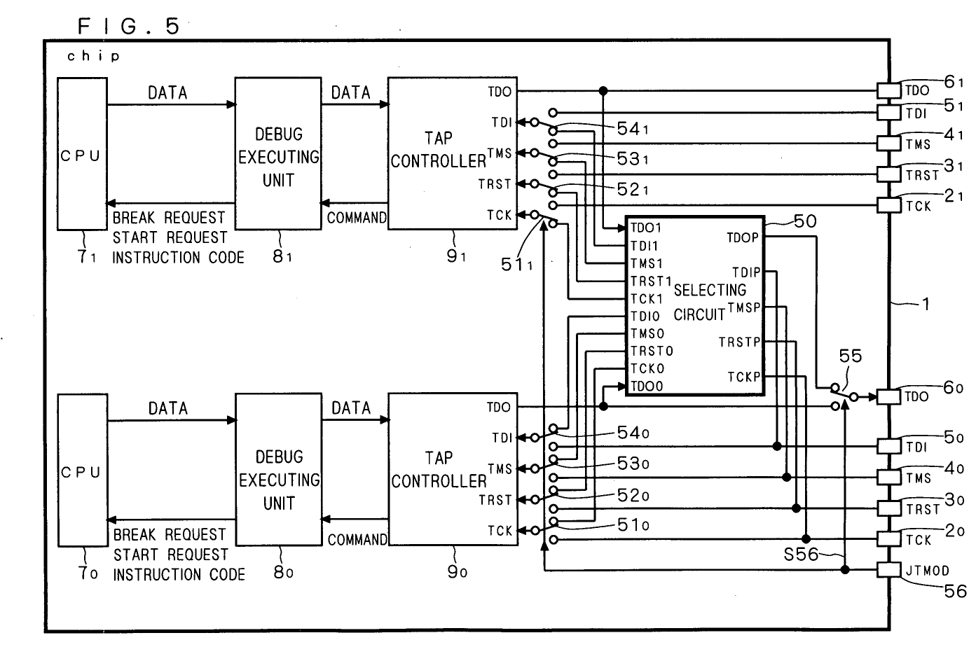

FIG. 5 is a block diagram showing the configuration of a multiprocessor system according to a fifth preferred embodiment of the invention. A chip 1 includes a plurality of CPUs 7₀ and 7₁, debug executing units 8₀ and 8₁ for executing the debugging of the CPUs 7₀ and 7₁, TAP controllers 9₀ and 9₁ for controlling the debug executing units 8₀, 8₁, a first set of terminals including terminals 2₀ to 6₀, and a second set of terminals including terminals 2₁ to 6₁.

The multiprocessor system of the fifth preferred embodiment can switch between a first mode and a second mode; in the first mode, first and second debugging devices are connected respectively to the first and second sets of terminals, and in the second mode, the first debugging device is connected only to the first set of terminals. The first mode and the second mode are switched using a terminal 56 and switches 51₀ to 54₀, 51₁ to 54₁, and 55.

The multiprocessor system of the fifth preferred embodiment further includes a selecting circuit 50 for, in the second mode, selectively supplying one or both of the TAP controllers 9₀, 9₁ with the debugging signals that are sent from the first debugging device through the first set of terminals. The selecting circuit 50 can be constructed similarly to the selecting circuits 10 and 20 of the first and second preferred embodiments.

The CPUs 7₀ and 7₁ are connected respectively to the debug executing units 8₀ and 8₁ and the debug executing units 8₀ and 8₁ are connected respectively to the TAP controllers 9₀ and 9₁. The TCK terminal, TRST terminal, TMS terminal, and TDI terminal of the TAP controller 9₀ are connected, respectively through the switches 51₀ to 54₀, to the terminals 2₀ to 5₀ and to the TCK0 terminal, TRST0 terminal, TMS0 terminal, and TDI0 terminal of the selecting circuit 50. The TDO terminal of the TAP controller 9₀ is connected to the TDO0 terminal of the selecting circuit 50, and also to the terminal 6₀ through the switch 55. Similarly, the TCK terminal, TRST terminal, TMS terminal, and the TDI terminal of the TAP controller 9₁ are connected, respectively through the switches 51₁ to 54₁, to the terminals 2₁ to 5₁ and to the TCK1 terminal, TRST1 terminal, TMS1 terminal, and TDI1 terminal of the selecting circuit 50. The TDO terminal of the TAP controller 9₁ is connected to the TDO1 terminal of the selecting circuit 50 and also to the terminal 6₁.

The selecting circuit 50 has a TDOP terminal connected to the terminal 6₀ through the switch 55. The TCKP terminal, TRSTP terminal, TMSP terminal, and TDIP terminal of the selecting circuit 50 are connected to the terminals 2₀ to 5₀, respectively.

The switches 51₀ to 54₀, 51₁ to 54₁, and 55 are switched (i.e. the first mode and the second mode are switched) on the basis of an external signal S56 applied to the terminal 56.

Next, operation of the multiprocessor system of the fifth preferred embodiment is described. The operation in the first mode is described first. In the first mode, the switches 51₀ to 54₀ are connected respectively to the terminals 2₀ to 5₀, the switches 51₁ to 54₁ are connected respectively to the terminals 2₁ to 5₁, and the switch 55 is connected to the TDO terminal of the TAP controller 9₀. Thus the TAP controller 9₀ is directly connected to the terminals 2₀ to 6₀ and the TAP controller 9₁ is directly connected to the terminals 2₁ to 6₁. Then the CPU 7₀ is debugged by the first debugging device connected to the terminals 2₀ to 6₀, and the CPU 7₁ is debugged by the second debugging device connected to the terminals 2₁ to 6₁.

Next, the operation in the second mode is described. In the second mode, the switches 51₀ to 54₀, 51₁ to 54₁, and 55 are connected to the selecting circuit 50 as shown in FIG. 5. Thus the TAP controllers 9₀ and 9₁ are connected to the terminals 2₀ to 6₀ through the selecting circuit 50. Then, as shown in the first and second preferred embodiments, the selecting circuit 50 selects at least one of the CPUs 7₀ and 7₁ to be debugged. Then debugging process is performed by the first debugging device connected to the terminals 2₀ to 6₀.

As shown above, according to the multiprocessor system of the fifth preferred embodiment, when the same number of debugging devices as the CPUs 7₀ and 7₁ provided in the chip 1 can be prepared, the first mode can be selected to independently debug the CPUs 7₀ and 7₁ with the plurality of debugging devices. On the other hand, when only a single debugging device is prepared, the second mode can be selected to debug the CPU(s) 7₀, 7₁ on the basis of a selection made by the selecting circuit 50.

Furthermore, the first and second modes can be switched over with a simple configuration using the terminal 56, which minimizes the size and complexity of the system.

### Sixth Preferred Embodiment

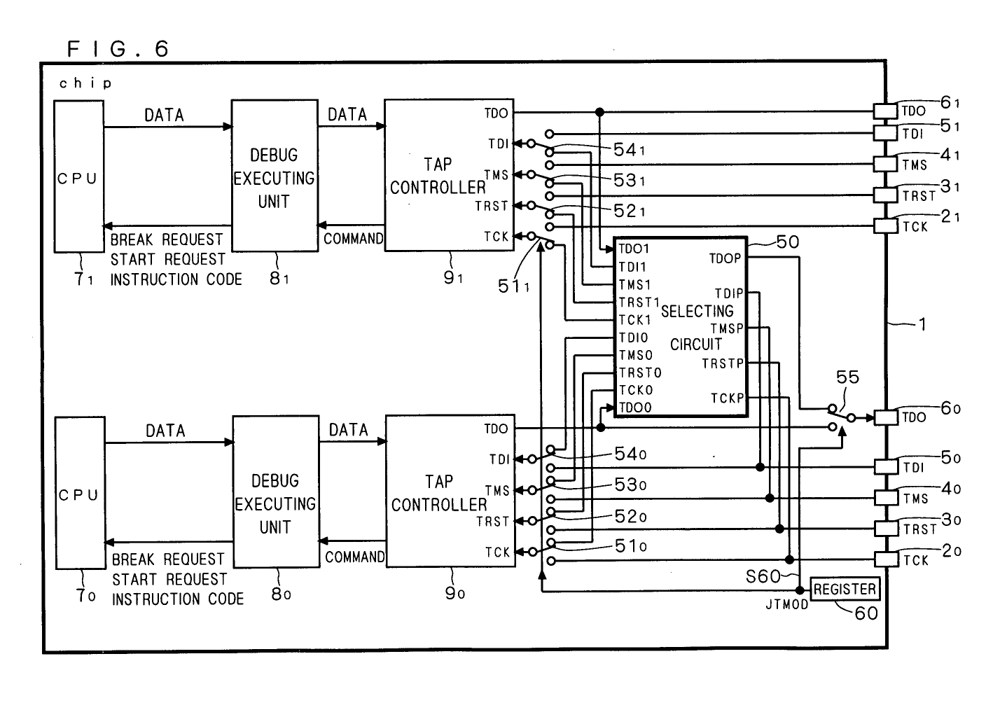

FIG. 6 is a block diagram showing the configuration of a multiprocessor system according to a sixth preferred embodiment of the invention. The fifth preferred embodiment has shown a system in which the first and second modes are switched on the basis of the signal S56 applied to the terminal 56 from outside. In contrast, the sixth preferred embodiment shows a system in which the first and second modes are switched on the basis of settings of a certain register 60 provided in the chip 1.

Referring to FIG. 6, the switches 51₀ to 54₀, 51₁ to 54₁, and 55 are switched on the basis of a signal S60 outputted from the register 60. Specifically, in the first mode, as in the fifth preferred embodiment, the switches 51₀ to 54₀ are connected respectively to the terminals 2₀ to 5₀ and the switches 51₁ to 54₁ are connected respectively to the terminals 2₁ to 5₁, and the switch 55 is connected to the TDO terminal of the TAP controller 9₀. On the other hand, in the second mode, the switches 51₀ to 54₀, 51₁ to 54₁, and 55 are connected to the selecting circuit 50. In other respects, the configuration and operation are the same as those shown in the fifth preferred embodiment and are not described here again.

Thus, according to the multiprocessor system of the sixth preferred embodiment, the first and second modes can be switched with a simple configuration using the register 60, which minimizes the size and complexity of the system.

### Seventh Preferred Embodiment

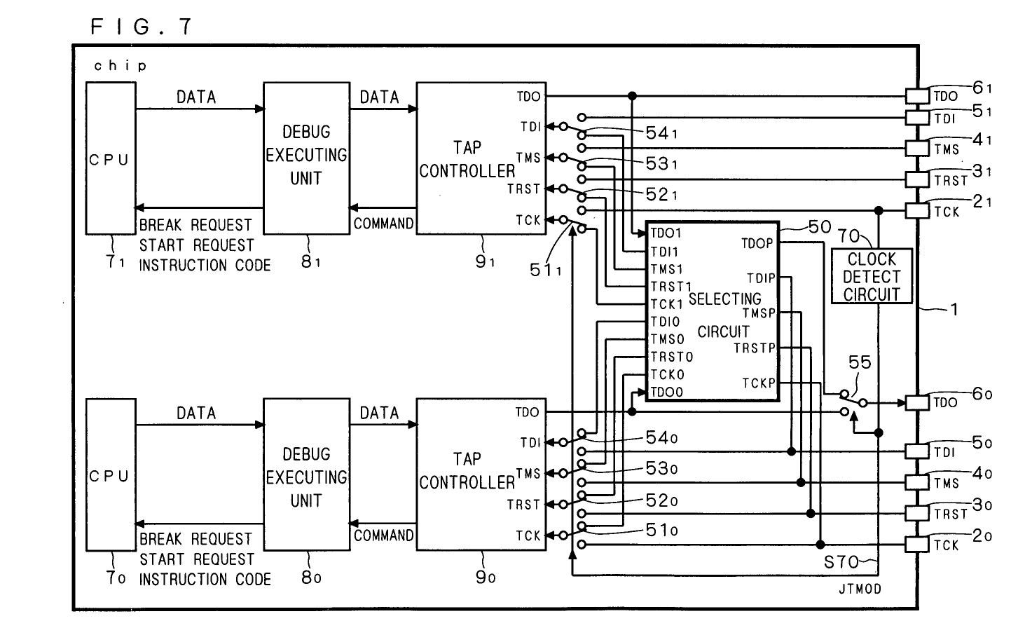

FIG. 7 is a block diagram showing the configuration of a multiprocessor system according to a seventh preferred embodiment of the invention. In the fifth preferred embodiment, the first mode and the second mode are switched on the basis of the external signal S56 applied to the terminal 56. In contrast, the multiprocessor system of the seventh preferred embodiment further includes a clock detect circuit 70 for detecting whether the second debugging device is connected to the second set of terminals, where the first mode and the second mode are switched on the basis of a signal S70 indicating the result detected by the clock detect circuit 70.

Referring to FIG. 7, the clock detect circuit 70 is connected to the terminal 2₁. When the second debugging device is connected to the second set of terminals, a clock is inputted to the clock detect circuit 70 from the second debugging device through the terminal 2₁. When the clock detect circuit 70 detects the clock input, then it connects the switches 51₀ to 54₀ respectively to the terminals 2₀ to 5₀, the switches 51₁ to 54₁ respectively to the terminals 2₁ to 5₁, and the switch 55 to the TDO terminal of the TAP controller 9₀. On the other hand, when the second debugging device is not connected to the second set of terminals, the clock is not inputted to the clock detect circuit 70. When detecting the absence of clock input, the clock detect circuit 70 connects the switches 51₀ to 54₀, 51₁ to 54₁, and 55 to the selecting circuit 50. In other respects the configuration and operation are the same as those described in the fifth preferred embodiment and are not described again here.

As shown above, according to the multiprocessor system of the seventh preferred embodiment, the first mode and the second mode are switched over with a simple configuration using the clock detect circuit 70, which minimizes the size the complexity of the system.

While the invention has been described in detail, the foregoing description is in all aspects illustrative and not restrictive. It is understood that numerous other modifications and variations can be devised without departing from the scope of the invention.

What is claimed is:

1. A multiprocessor system comprising:
a plurality of processors;
at least one debug executing unit for executing the debugging of said plurality of processors;
at least one controller for controlling said debug executing unit;
a set of terminals to be connected to an external debugging device; and
a selecting circuit for selecting, from among said plurality of processors, part or all of said plurality of processors to be debugged.

2. The multiprocessor system according to claim 1, wherein
said plurality of processors comprise first and second processors,
said debug executing unit comprises a first debug executing unit connected to said first processor and a second debug executing unit connected to said second processor,
said controller comprises a first controller connected to said first debug executing unit and a second controller connected to said second debug executing unit,
said selecting circuit is connected between said first and second controllers and said set of terminals, and
said selecting circuit inputs, to one or both of said first and second controllers, a debugging signal that is provided from said debugging device through said set of terminals.

3. The multiprocessor system according to claim 1, wherein
said plurality of processors comprise first and second processors,
said debug executing unit comprises a first debug executing unit connected to said first processor and a second debug executing unit connected to said second processor,
said selecting circuit is connected between said first and second debug executing units and said controller,
said controller is connected to said set of terminals, and
said selecting circuit inputs, to one or both of said first and second debug executing units, a debugging signal outputted from said controller.

4. The multiprocessor system according to claim 1, whererin
said plurality of processors comprise first and second processors,
said selecting circuit is connected between said first and second processors and said debug executing unit,
said debug executing unit is connected to said controller,
said controller is connected to said set of terminals, and
said selecting circuit inputs, to one or both of said first and second processors, a debugging signal outputted from said debug executing unit.

5. The multiprocessor system according to claim 1, wherein said selecting circuit selects said part or all of said plurality of processors to be debugged, on the basis of setting of a given register.

6. The multiprocessor system according to claim 1, wherein said selecting circuit selects said part or all of said plurality of processors to be debugged, on the basis of a select signal inputted to a given terminal from outside.

7. A multiprocessor system comprising:
first and second processors;
a first debug executing unit connected to said first processor and a second debug executing unit connected to said second processor;
a first controller connected to said first debug executing unit and a second controller connected to said second debug executing unit;
a first set of terminals selectively connected to said first controller and a second set of terminals selectively connected to said second controller; and
a selecting circuit connected between said first set of terminals and said first and second controllers;
wherein, in a first mode in which debugging devices are connected respectively to said first and second sets of terminals, said selecting circuit connects said first controller and said first set of terminals, and connects said second controller and said second set of terminals,
and wherein in a second mode in which said debugging device is connected only to said first set of terminals, said selecting circuit inputs, to one or both of said first and second controllers, a debugging signal provided from said debugging device through said first set of terminals.

8. The multiprocessor system according to claim 7, wherein said first mode and said second mode are switched on the basis of a select signal inputted to a given terminal from outside.

9. The multiprocessor system according to claim 7, wherein said first mode and said second mode are switched on the basis of setting of a given register.

10. The multiprocessor system according to claim 7, further comprising a detecting circuit for detecting whether said debugging device is connected to said second set of terminals,
wherein said first mode and said second mode are switched on the basis of a result detected by said detecting circuit.
